(19) United States
(12) Patent Application Publication
(10) Pub. No.: US 2016/0225478 A1
(43) Pub. Date: Aug. 4, 2016

(54) SUPERCONDUCTING MATERIAL AND METHOD OF MANUFACTURING SAME

(71) Applicant: AISIN SEIKI KABUSHIKI KAISHA, Kariya-shi (JP)

(72) Inventor: Shinji NEZU, Nagoya-shi (JP)

(73) Assignee: AISIN SEIKI KABUSHIKI KAISHA, Kariya-shi (JP)

(21) Appl. No.: 14/992,462

(22) Filed: Jan. 11, 2016

(30) Foreign Application Priority Data
Feb. 3, 2015 (JP) 2015-019159
Sep. 30, 2015 (JP) 2015-192726

(51) Int. Cl. H01B 1/02; H01B 12/00; C22C 38/00

(52) U.S. Cl. CPC H01B 1/02; C22C 38/002; H01B 12/00

(57) ABSTRACT

A superconducting material includes a mixture which includes iron particles and potassium as main components.

### CROSS REFERENCE TO RELATED APPLICATIONS

This application is based on and claims priority under 35 U.S.C. §119 to Japanese Patent Application 2015-192726, filed on Sep. 30, 2015, and Japanese Patent Application 2015-19159 filed on Feb. 3, 2015, the entire contents of which are incorporated herein by reference.

### TECHNICAL FIELD

This disclosure generally relates to a superconducting material and a method of manufacturing the superconducting material.

### BACKGROUND DISCUSSION

Metal such as niobium, for example, a metallic oxide such as a copper oxide, for example, an organic compound such as a bis(ethylenedithio)tetrathiafulvalene (BEDT-TTF) compound, for example, and a carbon-based compound such as a fullerene compound, for example, are known as a superconducting material.

A superconductive phenomenon appears normally at a low temperature. Nevertheless, in order to widely utilize the superconductive phenomenon, it is desirable that the superconductive phenomenon occurs at a higher temperature. Therefore, the superconducting material that represents superconductivity at the higher temperature has been eagerly searched. In addition, for a practical application, the superconducting material should be easily produced at a low cost.

Each of JP2010-231894A, which is hereinafter referred to as Reference 1, and Nature 464, 76-79 (2010) Superconductivity in alkali-metal-doped picene, which is hereinafter referred to as Reference 2, discloses an organic superconductor which includes an improved forming ability and in which picene is doped with alkaline metal or alkaline earth metal. According to Reference 1 and Reference 2, with a simple method where picene and alkali metal or alkaline earth metal are heated in vacuum at substantially 440K, the organic superconductor of which superconducting transition temperature is approximately 20K may be produced.

A need thus exists for a superconducting material and a method of manufacturing the superconducting material which are not susceptible to the drawback mentioned above.

### SUMMARY

According to an aspect of this disclosure, a superconducting material includes a mixture which includes iron particles and potassium as main components.

According to another aspect of this disclosure, a method of manufacturing a superconducting material includes a sealing process sealing a base material which includes iron particles and potassium within a container and a heating process heating the base material sealed in the container to a temperature lower than a melting point of iron and higher than a melting point of potassium to produce a mixture including iron particles and potassium as main components.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating susceptibility-temperature curve of a sample according to a reference example 1 disclosed here;

FIG. 2 is a diagram illustrating a polymer structural formula according to a reference example 2 disclosed here;

FIG. 3 is a diagram illustrating the susceptibility-temperature curve of a sample according to the reference example 2 disclosed here;

FIG. 4 is a diagram illustrating the susceptibility-temperature curve of a sample according to an embodiment 1 disclosed here;

FIG. 5 is a diagram illustrating the susceptibility-temperature curve of a sample according to an embodiment 2 disclosed here;

FIG. 6 is a diagram illustrating the susceptibility-temperature curve of a sample according to an embodiment 3 disclosed here;

FIG. 7 is a diagram illustrating the susceptibility-temperature curve of a sample according to an embodiment 4 disclosed here;

FIG. 8 is a diagram illustrating the susceptibility-temperature curve of a sample according to a comparative example 4 disclosed here;

FIG. 9 is a diagram illustrating the susceptibility-temperature curve of a sample according to a comparative example 5 disclosed here; and

FIG. 10 is a diagram illustrating the susceptibility-temperature curve of a sample according to a comparative example 6 disclosed here.

### DETAILED DESCRIPTION

First, a reproductive experiment was performed for reproducing an appearance of superconductivity of a mixture containing picene and potassium, i.e., picene doped with potassium, which is hereafter referred to as potassium (K)-doped picene, in accordance with JP2010-231894A (Reference 1) and Nature 464, 76-79 (2010) Superconductivity in alkali-metal-doped picene (Reference 2). In the reproductive experiment, picene with a purity equal to or greater than 99.9% and potassium with a purity of 99.95% were sealed in a Pyrex (“Pyrex” is a registered trademark) glass reaction tube inside of which was vacuum. Within the Pyrex glass reaction tube, the picene and the potassium were heated to a temperature of 440 K for reaction to produce K-doped picene. However, the superconductivity of the thus produced K-doped picene was not confirmable.

A magnetic susceptibility of the K-doped picene produced in the aforementioned reproductive experiment was measured and it was proved that the magnetic susceptibility of the K-doped picene was extremely smaller than a magnetic susceptibility of K-doped picene in a non-superconductive state (i.e., a magnetic susceptibility in a temperature range higher than a superconducting transition temperature) described in Reference 2. That is, the magnetic susceptibility of the K-doped picene in the non-superconductive state disclosed in Reference 2 is remarkably large. The reason why the K-doped picene in the non-superconductive state disclosed in Reference 2 is large is considered as below.

The magnetic susceptibility of a sample (K-doped picene) including a superconducting volume fraction of 15% is read as 9×10⁻⁴ emu/g in the temperature range greater than the superconducting transition temperature (7K) according to Reference 2. That is, the magnetic susceptibility of the K-doped picene in the non-superconductive state according to Reference 2 is 9×10⁻⁴ emu/g, which is much greater than a value normally observed as Pauli paramagnetic susceptibility. In Reference 2, such large magnetic susceptibility is interpreted as an influence by Curie paramagnetic impurities. Nevertheless, an existence of such large magnetic susceptibility is difficult to be explained unless ferromagnetic impurities are included in the sample as explained below.

When assuming that three-valent paramagnetic iron ions Fe³⁺ (spin quantum number S=5/2) exist as impurities in the K-doped picene, Curie paramagnetic susceptibility of the impurities estimated theoretically is derived by a formula (1) as below.

χT=N·g²·μB²·S·(S+1)/3k (1)

Where χ is a magnetic susceptibility [emu/mol], T is a temperature [K], N is an avogadro constant (6.02×10⁻²³), g is a g-factor, μB is a Bohr magneton [JT⁻¹], and k is a Boltzmann constant [JK⁻¹].

In a case where g=2, μB=9.27×10⁻²⁴, k=1.38×10⁻²³, and S=5/2 are plugged in the aforementioned formula (1), a formula (2) is obtained.

χT=43.6[(J·K)/(T²·mol)] (2)

Because of 1T=10⁴ G and 1J=10⁷ erg, a formula (3) is derived from the formula (2).

χT=4.36[(erg·K)/(G²·mol)] (3)

Accordingly, the magnetic susceptibility χ in a case where the temperature is 10 K is represented by a formula (4) as below.

χ=0.436[erg/(G²·mol)] (4)

Because an atomic masse of iron is 55.85 (1 mol=55.85 g), the magnetic susceptibility χ per unit gram in a case where the temperature is 10K is represented by a formula (5) as below.

χ=7.8×10⁻³[erg/G²·g]=0.0078[emu/g] (5)

As indicated by the aforementioned formula (5), the Curie paramagnetic susceptibility obtained by 1 g of Fe³⁺ is 0.0078 [emu/g]. Therefore, an amount of paramagnetic impurities generating the magnetic susceptibility of 9×10⁻⁴ [emu/g] corresponds to 0.12 g of iron. Nevertheless, it is unlikely that such great amount of paramagnetic impurities exist in the K-doped picene. Thus, it is appropriate to consider that ferromagnetic impurities generating a greater magnetic susceptibility are mixed in the K-doped picene.

A metallic tube such as a stainless tube, for example, is often utilized, instead of a glass tube, as a reaction vessel for a doping reaction of alkali metal, alkaline earth metal and the like as described in Reference 1 or 2. This is because a glass component is likely to react with alkali metal while iron includes characteristics not to form alloy or compound with alkali metal. Nevertheless, an iron oxide layer on a stainless surface is likely to be reduced by a strong reduction of alkali metal. Therefore, metallic iron that is reduced may be mixed in a sample.

In addition, in order to produce a sample for magnetization measurement, a powder sample may be pressed in a pellet form. Such powder sample is formed in the pellet with a die. The die may be generally made of iron-based material such as stainless, for example. Thus, metallic iron constituting the die may be mixed in the powder sample when the powder sample is press-formed.

Further, even in a case where a Pyrex tube is employed for a doping reaction of alkali metal, metallic iron may be mixed in the sample. For example, in a case where the Pyrex tube which is sealed is cut or a portion of the Pyrex tube is cut out, an iron-made file is often used. Thus, iron oxide resulting from rust of a surface of the file may be mixed in the sample within the Pyrex tube. The iron oxide that is mixed in the sample is likely to be reduced to metallic iron by alkali metal within the sample.

Accordingly, metallic iron (zero-valent metallic iron) may be highly possibly mixed in a potassium doping reaction product. It may be considered that the metallic iron from the outside is mixed in the K-doped picene in Reference 2. Then, it may be presumed or concluded that the metallic iron mixed in the K-doped picene is a cause of a high magnetic susceptibility and is related to the appearance of superconductivity. In this case, the appearance of superconductivity of the K-doped picene leads to two possibilities as below:

(1) The superconductivity appears in a case where metallic iron exists together with picene and potassium.
(2) A mixture where a main component is constituted by metallic iron and potassium exhibits the superconductivity.

A reference example 1 was prepared for verifying the superconductivity in a case where iron is mixed with K-doped picene. A base material was produced such that iron powder (powder obtained by scraping surfaces of two commercially available files containing iron) of 0.8% by weight was added to a mixture of picene (purity of 99.5%) and potassium (purity of 99.95%) (picene:potassium=1:3 in molar ratio). The material produced in the aforementioned manner was put in a Pyrex glass reaction tube which was vacuum-sealed and then heated at the temperature of 440K for five days to obtain picene doped with potassium (K-doped picene). A sample according to the reference example 1 was thus produced. The superconductivity of the sample according to the reference example 1 was investigated.

In order to investigate an existence of a superconducting material, i.e., in order to investigate the superconductivity of the sample, a SQUID flux meter is generally used. A temperature dependency of magnetization of the sample is measured by the SQUID flux meter as a ZFC (zero-field-cooling) curve and a FC (field cooling) curve. In a case where a magnetic transition point (critical point) exists in the measured ZFC curve and FC curve, it is determinable that the sample includes the superconductivity. With the clear superconductivity, the ZFC curve and the FC curve are generally separated from each other and a rapid decrease of magnetic susceptibility is observed at a temperature equal to or smaller than the superconducting transition temperature. Accordingly, a shielding effect of magnetic flux and a Meissner effect are confirmed. In a case where a ferromagnetic body (ferromagnet) is included in the sample, the ZFC curve and the FC curve are also separated from each other.

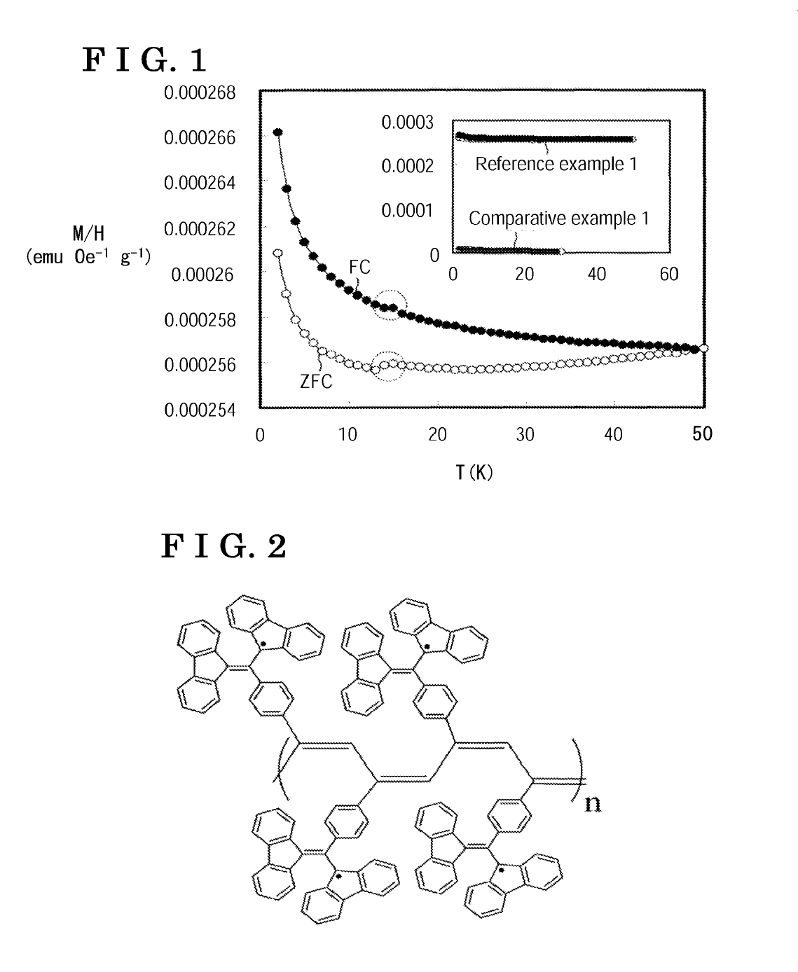

While the sample according to the reference example 1 was being vacuum-sealed in the tube, the temperature dependency of the magnetization of the sample was measured by the SQUID flux meter. FIG. 1 illustrates susceptibility-temperature curve (ZFC curve and FC curve) of the sample according to the reference example 1. An applied magnetic field H is 20 oersted. In FIG. 1, a horizontal axis indicates the temperature [K], a vertical axis indicates the magnetic susceptibility [emu Oe⁻¹ g⁻¹], a curve connecting open circles (symbols) is the ZFC curve, and a curve connecting filled circles (symbols) is the FC curve. In addition, an inset of FIG. 1 is a diagram indicating a comparison between the susceptibility-temperature curve of a sample according to a comparative example 1 which was produced under the similar condition to the sample of the reference example 1 except that iron powder was not added, and the susceptibility-temperature curve of the sample according to the reference example 1.

Based on the comparison between the samples of the reference example 1 and the comparative example 1, it is understood that the magnetic susceptibility remarkably increases by the addition of iron. Nevertheless, even when a great amount of iron powder (ferromagnetic impurities) of 0.8% by weight is mixed as in the reference example 1, the magnetic susceptibility is substantially 2.6×10⁻⁴ emu Oe⁻¹ g⁻¹, which is much smaller than the magnetic susceptibility of the K-doped picene in the non-superconductive state (9×10⁻⁴ emu Oe⁻¹g⁻¹)

In addition, in FIG. 1, it is understood that the ZFC curve and the FC curve are separated from each other in a temperature region from 2 K to 50 K. Such the separation indicates that ferromagnetic iron is included in the sample according to the reference example 1.

Further, the critical point (magnetic transition point) is obtained in the vicinity of the temperature of 15 K (i.e., a portion surrounded by dotted line) on each of the ZFC curve and the FC curve in FIG. 1. The aforementioned critical point indicates a superconducting transition (i.e., transition from ferromagnetism to superconducting). In the comparative example 1 where the iron powder is not mixed, the critical point (magnetic transition) is not observed. Accordingly, the critical point in FIG. 1 is considered resulting from the iron powder mixed in the K-dope picene.

Then, a chemical composition analysis of the iron powder employed in the sample according to the reference example 1 was performed with a glow discharge mass spectrometry. A quantitation result is shown as below.

Fe: 93%, C: 3%, Si: 3%, O: 1%, Mn: 7000 ppm, Na: 5200 ppm, Al: 4300 ppm, Ba: 3900 ppm, Ca: 3800 ppm, Cr: 2200 ppm, S: 1700 ppm, K: 930 ppm, Ni: 730 ppm, N: 730 ppm, Mg: 560 ppm, Sr: 470 ppm, Cu: 440 ppm, Cl: 320 ppm, Ti: 290 ppm, P: 150 ppm, Sn: 140 ppm, Pb: 150 ppm, Zr: 120 ppm, Sb: 93 ppm, Zn: 110 ppm, Co: 34 ppm, Ge: 24 ppm, V: 23 ppm, As: 20 ppm, Ga: 17 ppm, Mo: 14 ppm, Bi: 14 ppm, Li: 11 ppm, F: 7.5 ppm, B: 5.2 ppm, W: 3.3 ppm, Hf: 1.3 ppm, Y: 0.8 ppm, Ag: <500 ppm, Te, Ta: <10 ppm, I, Nb, Rh, Cd: <5 ppm, Cs, La: <2 ppm, Se, Ru, Ce: <1 ppm, Au, Pd, Rb, Br: <0.5 ppm, Be, Sc, Pr, Nd, Sm, Eu, Gd, Tb, Dy, Ho, Er, Tm, Yb, Lu, Re, Os, Ir, Pt, Hg, TI, Th, U: <0.1 ppm.

As indicated in the aforementioned quantitation result, though the majority of the iron powder used is iron (Fe), slightly greater amount, specifically, 3%, of carbon (C) and silicon (Si) were detected. This may be resulting from contamination by carborundum (silicon carbide: SiC) used for grinding by dry honing as a final finishing in a manufacture process of the iron-containing file. In order to confirm possibility that the aforementioned magnetic transition occurs by SiC doped with potassium, pure SiC and potassium were reacted to each other at various ratios to produce reactants (reaction products). Then, the temperature dependency of the/magnetization of each of the reaction products was measured by the SQUID flow meter. As a result, it is confirmed that the magnetic transition does not occur at the aforementioned reactants. It may be thus concluded that the existence of metallic iron (Fe) is highly related to the magnetic transition which appears on each of the ZFC curve and FC curve in FIG. 1.

A reference example 2 was prepared for verifying the superconductivity in a case where other organic than picene was used. A base material was produced by polymer including radical in a side-chain and polyacetylene main-chain to which potassium with three times of molar ratio was added. FIG. 2 illustrates a polymer structural formula used in the reference example 2.

Next, the base material produced in the aforementioned manner was vacuum-sealed within a Pyrex glass tube to be heated at the temperature of 440K for five days. A sample of the reference example 2 was thus produced.

It was confirmed by an ESR (Electron Spin Resonance) and a TEM (Transmission Electron Microscopy) that zero-valent metallic iron fine particles were generated in the sample because iron ions were reduced by potassium. In the polymer before potassium was added thereto, residue of oxidizer potassium ferricyanide for generating radical employed for polymer synthesis was included as trivalent iron ion hydroxide, oxyhydroxide or oxidant. It was considered that such iron ions changed to the zero-valent metallic iron (iron fine particles) by the reaction with potassium.

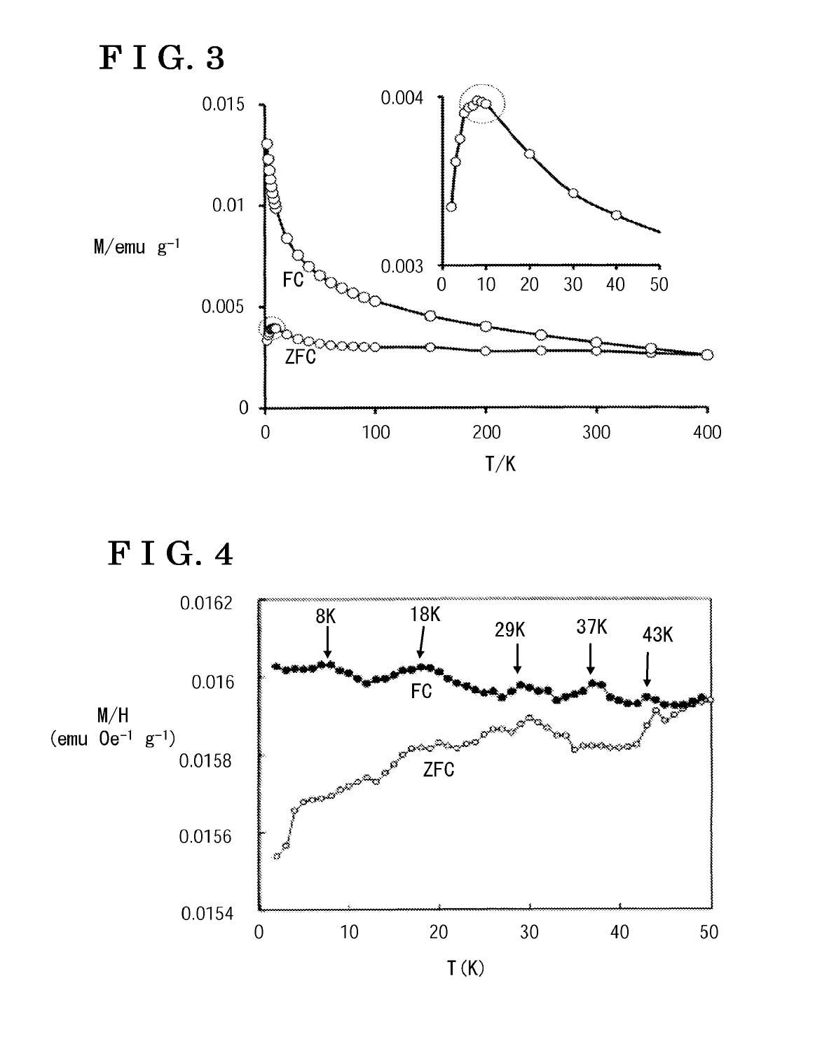

While the sample according to the reference example 2 was being vacuum-sealed in the tube, the temperature dependency of the magnetization of the sample was measured by the SQUID flux meter. FIG. 3 illustrates the susceptibility-temperature curve (ZFC curve and FC curve) of the sample according to the reference example 2 (applied magnetic field H=20 Oe). In FIG. 3, a horizontal axis indicates the temperature [K], and a vertical axis indicates the magnetic susceptibility [emu g⁻¹]. In addition, an inset of FIG. 3 is an enlarged view of the ZFC curve within a temperature range from 0 K to 50 K. As illustrated in FIG. 3, the ZFC curve and the FC curve are separated from each other within a temperature range from 2 K to 400 K. The aforementioned separation is considered resulting from ferromagnetism of the metallic iron generated in the aforementioned manner.

As is understood from FIG. 3, specifically, from the inset of FIG. 3, the magnetic transition point appears in the vicinity of the temperature of 10K (i.e., a portion surrounded by dotted line) on the ZFC curve of the sample according to the reference example 2. The aforementioned magnetic transition point indicates the superconducting transition. In a sample constituted by polymer only and not including potassium (comparative example 2) or a reactant (sample) of polymer where a content of iron impurities is equal to or less than 10 ppm and potassium (comparative example 3), such magnetic transition was not found. Accordingly, the magnetic transition in FIG. 3 is resulting from the potassium and the metallic iron in the sample, specifically, resulting from some sort of reaction between the potassium and the metallic iron. In addition, because the magnetic transition appears even in a case where other organic than picene is used, it may be concluded that picene is inhibited from contributing to the magnetic transition.

An embodiment 1 was prepared for verifying the superconductivity of a material constituted by a mixture including iron fine particles (iron perticles) and potassium as main components. In order to confirm that the magnetic transition (superconducting transition) observed in the reference examples 1 and 2 is irrelevant to picene or polymer and is resulting from some reaction between iron and potassium, the superconductivity of the material constituted by the mixture (i.e., iron-potassium mixture) including iron fine particles and potassium as the main components was investigated. In this case, 6.19 mg of iron powder (iron fine particles) obtained by scraping surfaces of two commercially-available files containing iron, which are the same as those used in the reference example 1, and 14 mg of potassium with the size of a grain of rice were employed as a base material. The aforementioned base material (iron fine particles and potassium) was sealed in a quarts (silica) glass tube (sealing process). Then, the base material sealed within the quarts glass tube (vessel) was heated to the temperature of 473 K (which is lower than a melting point of ion and higher than a melting point of potassium) for five days (heating process). By the heating, the potassium was dissolved within the quarts glass tube to make contact with the surfaces of the iron fine particles to thereby cause a reaction between iron and potassium and cause the dissolved potassium and the iron fine particles to be mixed. As a result, an integrated mixture where potassium and iron fine particles were dispersed (mixture where iron fine particles and potassium serve as the main components) was produced. Through the aforementioned process, a sample according to the embodiment 1, i.e., a superconducting material constituted by the mixture where potassium and iron particles serve as the main components was produced. While the thus produced sample was being vacuum-sealed in the tube, magnetization-temperature dependence was measured by the SQUID flow meter. FIG. 4 illustrates the susceptibility-temperature curve (ZFC curve and FC curve) of the sample according to the embodiment 1. In FIG. 4, a horizontal axis indicates the temperature [K] and a vertical axis indicates the magnetic susceptibility [emu Oe⁻¹ g⁻¹]. The applied magnetic field is 20 oersted.

As is understood from FIG. 4, the magnetic transitions appear at plural temperatures, specifically, at the temperatures of 8K, 18K, 29K, 37K and 43K on the FC curve. In addition, the magnetic transitions also appear at plural portions on the ZFC curve. The aforementioned magnetic transitions indicate the superconducting transitions.

The magnetic transition which indicates the superconducting transition occurs in the present embodiment in which picene and polymer are not employed. This means that the magnetic transition indicating the superconducting transition is irrelevant to picene or polymer and is caused by some reaction between iron and potassium. In addition, as seen from FIG. 4, the superconducting transition temperature of the mixture of iron and potassium is equal to or smaller than the temperature of 50K.

According to the aforementioned experimental fact, it is apparent that the magnetic transition phenomenon indicating the superconductivity is observed, without picene, by a mixture including iron fine particles and potassium as the main components, the mixture being obtained in a state where iron powder and potassium are reacted (i.e., heated) in vacuum at the temperature of 473K for several days.

It is considered that iron and potassium are inhibited from forming alloy or compound at a normal pressure. In addition, it is known that alkali metal is adsorbed on a surface of metal crystal such as iron, for example, to apply electron to thereby greatly change physical properties of metal. FeK catalyst used for the Fischer-Tropsch process, i.e., for converting a mixture of carbon monoxide and hydrogen into hydrocarbon, is an example. Electron injection by potassium is known to greatly influence a work function, for example. According to the sample of the embodiment 1, metallic potassium is considered to make contact with surfaces of iron fine particles which normally indicate ferromagnetism at a room temperature and to adsorb to iron crystal surfaces. Then, it is considered that the superconductivity appears at the surfaces of the iron fine particles to which the metallic potassium adsorbs, thereby causing a transition from ferromagnetism to superconducting (superconducting transition).

An embodiment 2 was prepared for verifying the superconductivity of a mixture of iron and potassium oxide. In the embodiment 2, the tube accommodating therein the sample according to the embodiment 1 was unsealed so that the sample was brought to make contact with air (oxygen). As a result, potassium in the sample was oxidized (oxidation process). The sample was left until potassium was completely oxidized, and thereafter was again put into the quarts glass tube. The quarts glass tube was sealed after the quarts glass tube was filled with low-pressure helium. The sample according to the embodiment 2 (superconducting material by a mixture including iron fine particles and potassium oxide as the main components) was thus produced.

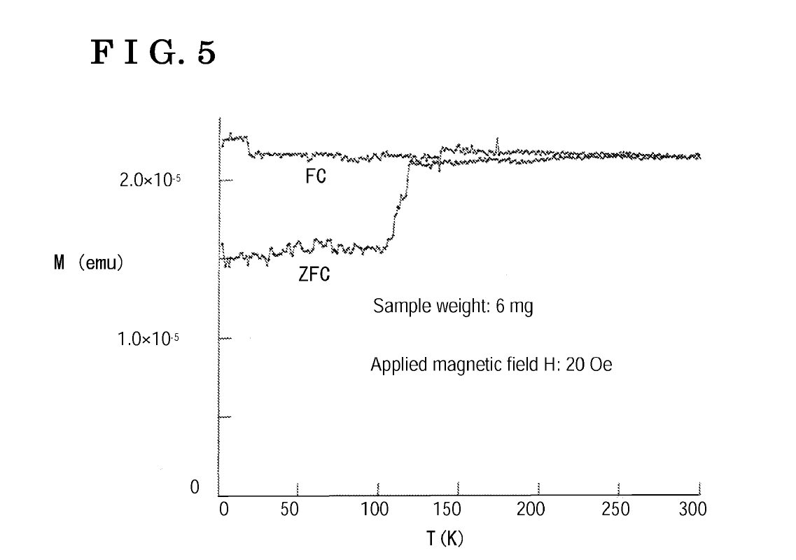

The magnetization-temperature dependence of the sample according to the embodiment 2 is measured by the SQUID flux meter. FIG. 5 illustrates the susceptibility-temperature curve (ZFC curve and FC curve) of the sample according to the embodiment 2. In FIG. 5, a horizontal axis indicates the temperature [K], and a vertical axis indicates the magnetic susceptibility [emu]. In addition, the applied magnetic field H is 20 oerste. As illustrated in FIG. 5, the magnetic transition which is distinctive for the superconductivity is observed around the temperature of 120K. Accordingly, it is understood that the superconducting transition temperature of the mixture of iron fine particles and potassium oxide is high as 120K.

Accordingly, as indicated by the sample of the embodiment 2, the superconducting material which exhibits the superconducting transition at the temperature of 120K may be produced easily at a reduced cost with iron powder and potassium. Such superconducting transition temperature (120K) is the second highest temperature behind a copper oxide-based semiconductor among superconductors which have been ever found, which leads to an extremely high industrial importance. In addition, as indicated by the embodiment 1, the plural transition temperatures are observed depending on experimental conditions. Thus, further detailed investigation of optimal conditions may increase the transition temperature and expect feasibility of room temperature superconducting.

It is confirmed that a material produced by mixing and heating potassium and iron powder (iron fine particles) obtained by scraping two commercially available iron-containing files may exhibit superconducting characteristics as indicated by the embodiment 1, however, may not exhibit the superconducting characteristics depending on a product lot of the file to be used. This indicates that other element(s) than iron included in the iron-containing file may influence the appearance of superconductivity. In a case where a quantitative analysis is performed on main impurities included in the commercially available iron-containing file, various elements as indicated by the reference example 1 are detected. Among such the detected elements, carbon, silicon, oxygen, manganese, strontium, barium, chromium and the like serve as main impurities.

Here, an influence of the elements of the main impurities included in a mixture containing iron-based powder (iron fine particles) and potassium as the main component relative to the appearance of superconductivity was researched. As a result, it was found that even in a case where soft magnetic iron powder including a relatively high purity and potassium were mixed together, clear superconducting transition was not observed. On the other hand, in a case where iron powder (iron fine particles) including relatively large amount of oxygen and strontium as impurities was mixed with potassium, clear superconducting transition was observed. It is considered that, in iron power including a great amount of oxygen, a portion of metallic iron is oxidized to exist as iron ions. Thus, it is assumed that a material serving as an origin (cause) of the appearance of superconductivity is generated and obtained by mixing iron ions, oxygen and strontium in iron powder (iron fine particles) and potassium and by heating the mixture. In the aforementioned assumption, a composition of the material serving as the origin of the appearance of superconductivity and a mechanism of the appearance of superconductivity caused by such the material are not clearly specified at the moment, however, two possibilities are considered as below.

A: First, it may be considered that a compound SrFeO₂ including strontium, iron and oxygen as constituent elements serves as the origin of the appearance of superconductivity. The compound bears a square-planar oxygen coordination around a Fe atom where the Fe atom connects four oxygen atoms as a square planer coordination. The plural squares connect one another to form two-dimensional FeO planes which alternately overlap, in a sandwiched manner, with planes formed by strontium. The two-dimensional FeO plane is extremely similar to CuO₂ plane that fulfils a critical role for the appearance of superconductivity in a copper oxide based high temperature superconductor. Thus, it is considered that SrFeO₂ is carrier-doped with potassium so that the superconductivity appears. Normally, SrFeO₂ is synthesized by reducing SrFeO₃ by metal hydride, for example. At this time, it is considered that SrFeO₂ may be also generated by applying potassium to iron powder including iron, strontium and oxygen. Then, as a result of a hole-doped body where Sr (strontium) in the generated SrFeO₂ is substituted or replaced by K (potassium) or an electron-doped body where potassium intrudes SrFeO₂, the superconductivity appears.

B: Second, it may be considered that strontium is irrelevant to the superconducting and iron oxide is reduced by potassium to form iron fine particles. Then, potassium atoms are adsorbed on surfaces of the iron fine particles (iron surface) so that electron is injected to the iron surface to thereby cause the appearance of superconductivity. The electron injected to the iron surface is considered to exist to be delocalized in a wide range. Iron possibly exhibits the superconductivity in a range, i.e., in a range where the electron is injected. In this case, the inside of the iron fine particles corresponds to a normal ferromagnet and only the iron surface changes to a superconductor. Thus, it is considered that the iron fine particles with a great effect of surface may increase the appearance of superconductivity. In addition, in a case where potassium is applied to iron fine particles which include a large oxygen content, iron is reduced by the potassium to generate metallic iron (pure iron) fine particles. Then, the potassium is adsorbed on the reduced metallic iron fine particles and electron is injected to the metallic iron particles from the potassium to thereby cause the appearance of superconductivity. A structure of potassium atoms adsorbed on a metal surface and a local electronic state have been investigated and studied with a low-temperature STM in a case where copper is employed as metal. According to the aforementioned investigation, it has been reported that the work function decreases by the adsorption of potassium atoms on copper surface. It is considered that the similar phenomenon may occur in a case where iron is employed as metal.

Based on the aforementioned two possibilities A and B, the appearance of superconductivity was investigated on samples according to embodiments 3 and 4 in each of which oxygen (O) of equal to or greater than a predetermined amount and/or strontium (Sr) of equal to or greater than a predetermined amount were contained in a mixture including iron fine particles and potassium as the main components.

Iron powder (iron fine particles) was produced by scraping surfaces of two commercially available iron-containing files. Then, kinds and amount of impurities included in the aforementioned iron powder were analyzed quantitatively by a glow discharge mass spectrometry. The result is as follows:
Oxygen (O): 11000 ppm
Carbon (C): 11000 ppm
Silicon (Si): 19000 ppm
Manganese (Mn): 13000 ppm
Chrome (Cr): 3400 ppm
Strontium (Sr): 1600 ppm
Barium (Br): 3800 ppm
   As is understood from the aforementioned mass resolution result, the iron fine particles include 11000 ppm (i.e., equal to or greater than 10000 ppm) of oxygen (O) and 1600 ppm (i.e., equal to or greater than 1500 ppm) of strontium as the impurities.

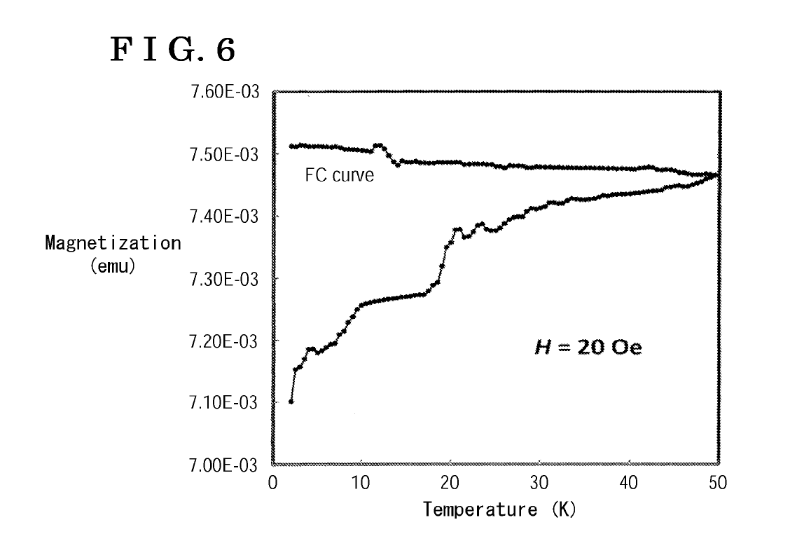

5.68 mg of iron powder including oxygen and strontium each of which equal to or greater than the predetermined amount obtained in the aforementioned manner and 13 mg of metallic potassium, the iron powder and the metallic potassium serving as a base material, were put into a NMR tube with a 5 mm diameter. Small amount of helium was put into the NMR tube after vacuuming thereof and was sealed (sealing process). The base material within the sealed NMR tube was left in a muffle furnace at 200° C. (473 K) for 5 days to heat (react) the base material (heating process). As a result, a mixture including iron fine particles and potassium as the main components and containing oxygen and strontium was produced. Through the aforementioned processes, a sample according to the embodiment 3, i.e., a superconducting material constituted by the mixture including iron fine particles and potassium as the main components and containing oxygen and strontium was produced. The sample according to the embodiment 3 was taken out from the muffle furnace to measure the susceptibility-temperature curve of the sample with the SQUID flux meter. The applied magnetic field was 20 oersted. FIG. 6 shows the measured susceptibility-temperature curve. As illustrated in FIG. 6, in the sample of the embodiment 3, a clear superconducting transition is found around the temperatures of 10 K and 20 K.

Iron powder (iron fine particles) was produced by scraping surfaces of two commercially available iron-containing files which were different from those used in the embodiment 3. Then, kinds and amount of impurities included in the aforementioned iron powder were analyzed quantitatively by the glow discharge mass spectrometry. The result is as follows:
Oxygen (O): 37000 ppm
Carbon (C): 15000 ppm
Silicon (Si): 45000 ppm
Manganese (Mn): 13000 ppm
Chrome (Cr): 4200 ppm
Strontium (Sr): 6000 ppm
Barium (Br): 11000 ppm
   As is understood from the aforementioned mass resolution result, the iron fine particles include 37000 ppm (i.e., equal to or greater than 10000 ppm) of oxygen (O) and 6000 ppm (i.e., equal to or greater than 1500 ppm) of strontium as the impurities.

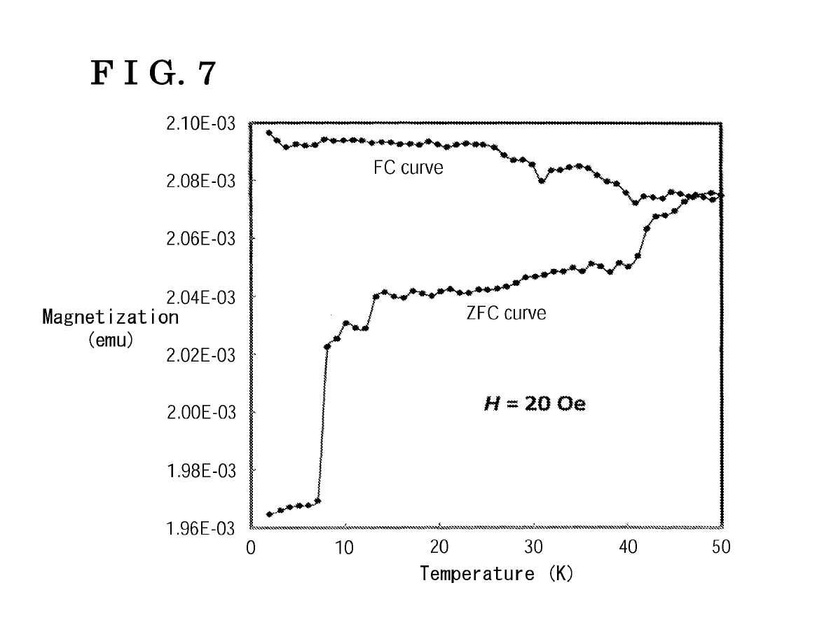

7.77 mg of iron powder including oxygen and strontium each of which equal to or greater than the predetermined amount obtained in the aforementioned manner and 14 mg of metallic potassium, the iron powder and the metallic potassium serving as a base material, were put into a NMR tube with a 5 mm diameter. Small amount of helium was put into the NMR tube after vacuuming thereof and was sealed (sealing process). The base material within the sealed NMR tube was left in a muffle furnace at 200° C. (473 K) for 5 days to heat (react) the base material (heating process). As a result, a mixture including iron fine particles and potassium as the main components and containing oxygen and strontium was produced. Through the aforementioned processes, a sample according to the embodiment 4, i.e., a superconducting material constituted by the mixture including iron fine particles and potassium as the main components and containing oxygen and strontium was produced. The sample according to the embodiment 4 was taken out from the muffle furnace to measure the susceptibility-temperature curve of the sample 4 with the SQUID flux meter. The applied magnetic field was 20 oersted. FIG. 7 shows the measured susceptibility-temperature curve. As illustrated in FIG. 7, in the sample of the embodiment 4, a clear superconducting transition is found around the temperatures of 8 K and 43 K.

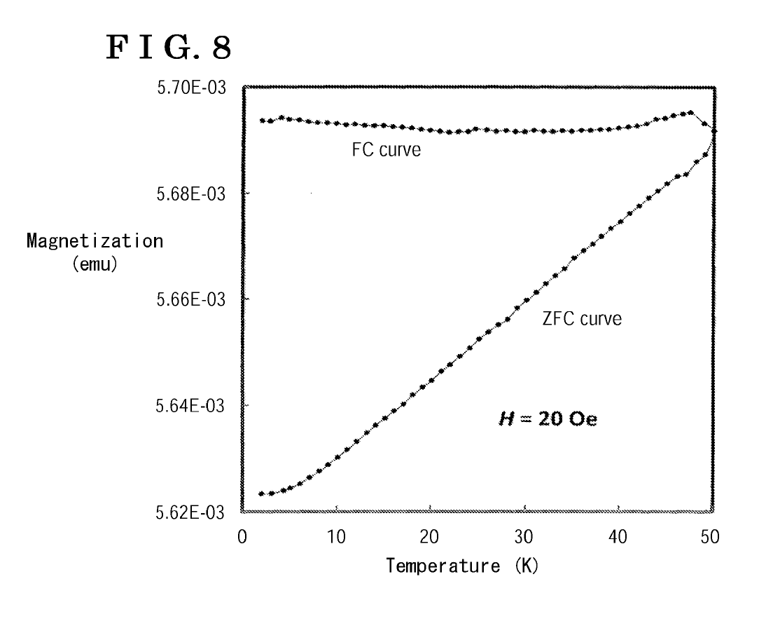

A sample according to a comparative example 4 is constituted by only the iron powder employed in the embodiment 3. The susceptibility-temperature curve of the sample was measured with the SQUID flow meter. The applied magnetic field for the measurement was 20 oersted. The measurement result is shown in FIG. 8. As illustrated in FIG. 8, the sample of only the iron powder according to the comparative example 4 simply shows a typical ferromagnetic behavior and the superconducting transition is not found.

Iron powder (iron fine particles) was produced by scraping surfaces of two commercially available iron-containing files which were different from those used in the embodiment 3 or 4. Then, kinds and amount of impurities included in the aforementioned iron powder were analyzed quantitatively by the glow discharge mass spectrometry. The result is as follows:
Oxygen (O): 2100 ppm
Carbon (C): 9300 ppm
Silicon (Si): 7300 ppm
Manganese (Mn): 5800 ppm
Chrome (Cr): 24000 ppm
Strontium (Sr): 11 ppm
Barium (Br): 730 ppm
   As is understood from the aforementioned mass resolution result, the iron fine particles include less than 10000 ppm of oxygen (O) (specifically, 21000 ppm) as the impurity and less than 1500 ppm of strontium (Sr) (specifically, 11 ppm) as the impurity.

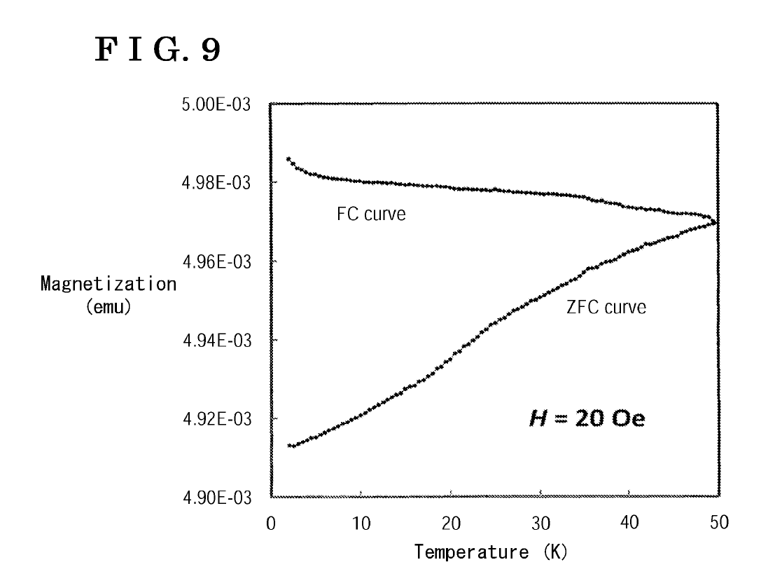

A sample according to a comparative example 5 was produced in the similar method to those in the embodiments 3 and 4 with 5.20 mg of iron powder and 22 mg of metallic potassium. The susceptibility-temperature curve of the sample according to the comparative example 5 was measured with the SQUID flow meter. The applied magnetic field was 20 oersted. FIG. 9 shows the measurement result. As illustrated in FIG. 9, the superconducting transition is not found in the sample of the comparative example 5.

Soft magnetic powder which includes a relatively high purity and which is commercially available was prepared. Then, kinds and amount of impurities included in the aforementioned soft magnetic powder were analyzed quantitatively by the glow discharge mass spectrometry. The measurement result is as follows.
Oxygen (O): 230 ppm
Carbon (C): 50 ppm
Silicon (Si): 200 ppm
Manganese (Mn): 1900 ppm
Chrome (Cr): 460 ppm
Strontium (Sr): 0.7 ppm
Barium (Br): 1.1 ppm
   As is understood from the aforementioned mass resolution result, the soft magnetic powder includes less than 10000 ppm of oxygen (O) (specifically, 230 ppm) and less than 1500 ppm of strontium (Sr) (specifically, 0.7 ppm).

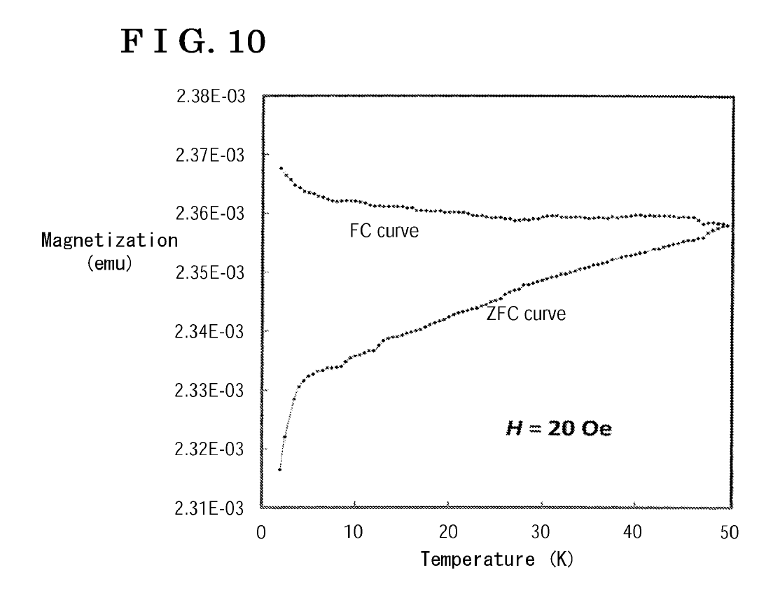

A sample according to a comparative example 6 was produced in the similar method to those of the embodiments 3 and 4 with 5.3 mg of the aforementioned soft magnetic powder and 17 mg of potassium. The susceptibility-temperature curve of the sample according to the comparative example 6 was measured with the SQUID flow meter. The applied magnetic field was 20 oersted. The measurement result is shown in FIG. 10. As illustrated in FIG. 10, the superconducting transition is not found in the sample of the comparative example 6.

Based on the results of the embodiments 3, 4 and the comparative examples 4, 5 and 6, in a case where oxygen (O) of equal to or greater than the predetermined amount (specifically, equal to or greater than 10000 ppm) is contained in the mixture which includes iron fine particles and potassium as the main components (or the base material for producing the mixture including iron fine particles and potassium as the main components), and in a case where oxygen (O) of equal to or greater than the predetermined amount (specifically, equal to or greater than 10000 ppm) and strontium (Sr) of equal to or greater than the predetermined amount (specifically, equal to or greater than 1500 ppm) is contained in the mixture which includes iron fine particles and potassium as the main components (or the base material for producing the mixture including iron fine particles and potassium as the main components), it is understood that the superconducting transition is observed at the material constituted by such the mixture. As the reason why the superconductivity appears in a case where oxygen (O) of equal to or greater than the predetermined amount (specifically, equal to or greater than 10000 ppm) is contained in the mixture which includes iron fine particles and potassium as the main components (or the base material for producing the mixture including iron fine particles and potassium as the main components), the aforementioned second possibility (B) is considered. In addition, as the reason why the superconductivity appears in a case where oxygen (O) of equal to or greater than the predetermined amount (specifically, equal to or greater than 10000 ppm) and strontium (Sr) of equal to or greater than the predetermined amount (specifically, equal to or greater than 1500 ppm) is contained in the mixture which includes iron fine particles and potassium as the main components (or the base material for producing the mixture including iron fine particles and potassium as the main components), the aforementioned first possibility (A) is considered.

As mentioned above, in the embodiments, the new superconducting material containing ion and potassium is found. In a known method of producing a high temperature superconducting material, sintering at a high temperature is generally required. In addition, expensive chemical element(s) and/or harmful material(s) may be required. On the other hand, in the embodiments, the cheap and safe base material (iron and potassium) is used as the main component and the superconducting material may be produced at a relatively low temperature condition. A scientific explanation of a high temperature superconducting has not yet achieved and details are unclear for the materials in the disclosure. Nevertheless, the electron injection to iron or the electron or hole injection to a FeO plane may be considered as a trigger of superconducting transition.

In the embodiments, a superconducting material includes a mixture which includes iron particles and potassium as main components.

In addition, in the embodiments, a method of manufacturing a superconducting material includes a sealing process sealing a base material which includes iron particles and potassium within a container and a heating process heating the base material sealed in the container to a temperature lower than a melting point of iron and higher than a melting point of potassium to produce a mixture including iron particles and potassium as main components.

The superconducting material according to the embodiments is constituted by the mixture including iron and potassium which serve as the main components and which are easily obtainable, which leads to a low cost. In addition, the superconducting material may be produced through a simple process for heating the base material which includes iron fine particles and potassium as the main components and which is sealed within a container (tube). Further, the superconducting transition temperature of the superconducting material produced in the aforementioned manner is relatively high. Thus, the superconducting material which is practicable and utilized for various uses may be provided.

In the embodiments, the potassium in the mixture is in contact with surfaces of the iron particles.

In addition, the potassium in the mixture is oxidized.

Further, the mixture includes oxygen.

Further, the mixture includes strontium.

Further, the method further includes an oxidation process oxidizing the potassium in the mixture by bringing the mixture to make contact with oxygen.

Further, the base material includes oxygen.

Further, a content of the oxygen is equal to or greater than 10000 ppm.

Further, the base material includes strontium.

Further, a content of the strontium is equal to or greater than 1500 ppm.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A superconducting material comprising a mixture which includes iron particles and potassium as main components.

2. The superconducting material according to claim 1, wherein the potassium in the mixture is in contact with surfaces of the iron particles.

3. The superconducting material according to claim 1, wherein the potassium in the mixture is oxidized.

4. The superconducting material according to claim 1, wherein the mixture includes oxygen.

5. The superconducting material according to claim 4, wherein the mixture includes strontium.

6. A method of manufacturing a superconducting material, comprising:
a sealing process sealing a base material which includes iron particles and potassium within a container; and
a heating process heating the base material sealed in the container to a temperature lower than a melting point of iron and higher than a melting point of potassium to produce a mixture including iron particles and potassium as main components.

7. The method according to claim 6, further comprising an oxidation process oxidizing the potassium in the mixture by bringing the mixture to make contact with oxygen.

8. The method according to claim 6, wherein the base material includes oxygen.

9. The method according to claim 8, wherein a content of the oxygen is equal to or greater than 10000 ppm.

10. The method according to claim 8, wherein the base material includes strontium.

11. The method according to claim 10, wherein a content of the strontium is equal to or greater than 1500 ppm.
